(19) United States
(12) Patent Application Publication
(10) Pub. No.: US 2021/0394853 A1
(43) Pub. Date: Dec. 23, 2021

(54) Pressurized Liquid Reservoir Vessel for Bicycle

(71) Applicant: William Steiner, San Francisco, CA (US)

(72) Inventor: William Steiner, San Francisco, CA (US)

(21) Appl. No.: 16/905,574

(22) Filed: Jun. 18, 2020

(51) Int. Cl. B62J 11/04

(52) U.S. Cl. CPC B62J 11/04

(57) ABSTRACT

A hydration system for cyclists comprising of a pressurized liquid reservoir vessel, a reservoir holder mounted in the bottom vertex of a bicycle and a U-shaped wrap around the reservoir vessel and the reservoir holder. The pressurized liquid reservoir vessel of the present invention further comprises of a polygonal prism body, a pump, a hose and a nozzle

### FIELD OF THE INVENTION

The present invention relates to a hydration system in general, more particularly to a hydration system affixed to a bicycle frame with easy access and maximum capacity for beverage for cyclists.

### BACKGROUND OF THE INVENTION

Cyclists when riding for long duration need hydration for which they use water bottles which are mounted within the frame of the bike. However, water bottles and bottle mount options that are currently used by cyclists leave a lot of unused, negative space within the bike frame. The carrying capacity when standard water bottles and traditional mount options are used for hydration is capped out around 1250-1500 ml. Thus, the limited water capacity can be a problem where cyclists need hydration for extended periods of time.

Further, cyclists need to reach down to grab bottles which can be an inconvenience on a loaded bike or in an uneven terrain. It can also distract them resulting in accidents.

In addition, the traditional mounting options to retain water bottles do not provide any flexibility with respect to the container storing liquid. One is stuck with the apparatus that comes with the mounting option.

Therefore, a need remains for a hydration system that can not only maximize the water storage capacity but also an access to the said liquid in a way that does not require the rider to reach down to grab a water bottle. Further, there is a need for an adaptable mounting option that can retain both standard water bottles or a vessel with double storage capacity.

### SUMMARY OF THE INVENTION

This Summary is provided to introduce a selection of concepts in a simplified form that are further described below in the Detailed Description of the invention. This Summary is not intended to identify key aspects or essential aspects of the claimed subject matter. Moreover, this Summary is not intended for use as an aid in determining the scope of the claimed subject matter.

The present application discloses a hydration system for cyclists while riding their bikes.

It is an object of this invention to provide a hydration system for cyclists comprising of a reservoir vessel, a reservoir holder and a U-shaped wrap.

It is an object of this invention to provide a detachable liquid reservoir vessel in a reservoir holder mounted on a bicycle frame to retain the said liquid reservoir vessel. The liquid reservoir vessel of the present invention may include a pressurized liquid reservoir or a standardized water bottle.

The pressurized liquid reservoir vessel of the present invention further comprises a polygonal prism body, a pump, a hose and a nozzle. The polygonal prism body of the pressurized liquid vessel consists of five edges and a first and a second surface separated by a thickness of the prism body.

It is another object of this invention to provide a U-shaped wrap surrounding the liquid reservoir vessel held within the reservoir holder mounted on a bicycle frame.

It is still another object of this invention to provide a pressurized liquid reservoir vessel which effectively doubles the water carrying capacity within the frame of the bicycle.

It is yet another object of this invention to provide a pressurized flow of water from a reservoir vessel secured in a reservoir holder without interfering with the operation of the bicycle.

It is a further object of this invention to provide a thermally insulated blanket cover to maintain the temperature of the liquid stored in the reservoir vessel wherein the thermally insulated blanket cover overlaps the U-shaped wrap which further surrounds a pressurized liquid reservoir vessel mounted on the frame of a bike.

In a preferred embodiment, a hydration system affixed in a bottom vertex of a bicycle comprising a detachable polygonal prism reservoir vessel consisting of five edges and a first and a second surface separated by a thickness of the prism body; wherein the first edge is a bottom edge configured to be in close proximity to the down tube of a bicycle and substantially parallel to the down tube of the bicycle; wherein the second edge and third edge are approximately at right angles to the bottom edge; wherein the second edge meets with a fourth edge which extends at an angle away from the second edge and the said fourth edge is substantially parallel with the seat tube of the bicycle; wherein the third edge meets with a fifth edge which extends at an angle away from the third edge and the said fifth edge is substantially parallel with the top tube of the bicycle; wherein the said fifth edge meets with the said fourth edge; wherein the said reservoir vessel comprises a first opening and a second opening on the fifth edge of the vessel; wherein the said first opening includes a pump when actuated provides a pressurized flow of water to the rider and the said second opening includes an adaptor for connecting a hose; wherein the said hose is positioned along a tube of the bicycle and extended till the handlebar of the bicycle to provide water with a nozzle at its distal end; a reservoir vessel holder with a dovetail angle design; wherein the said reservoir holder is mounted on the down tube of a bicycle and secures the reservoir vessel in place within the frame of the bicycle; a U-shaped wrap around the bottom edge of the reservoir vessel to receive the reservoir vessel; wherein the said U-shaped wrap includes a top substantially u-shaped channel at one end near the third edge of the reservoir vessel and a bottom substantially u-shaped channel at the other end near the second edge of the reservoir vessel thereby forming a curved surface around the first surface and the second surface of the vessel and extending between the bottom and the top U-shaped channel; wherein the reservoir holder engage the bottom substantially u-shaped channel, the top substantially u-shaped channel and the curved surface extending between the bottom U-shaped channel and the top U-shaped channel; and an insulated cover with a shape substantially similar to that of the polygonal prism body of the reservoir vessel surrounding the U-shaped wrap, the reservoir holder and the reservoir vessel.

These together with other objects and advantages which will become subsequently apparent reside in the details of the invention as more fully described and claimed, reference being had to the accompanying drawings forming a part thereof, wherein like numerals refer to like parts throughout.

### BRIEF DESCRIPTION OF THE DRAWINGS

The novel features of the invention, as well as the invention itself, both as to its structure and its operation will be best understood from the accompanying drawings, taken in conjunction with the accompanying description, in which similar reference characters refer to similar parts, and in which:

FIG. 1: shows a side view of pressurized liquid reservoir vessel;

FIG. 2: shows a view of pressurized liquid reservoir vessel mounted on the bottom tube of a bicycle;

FIG. 3: shows a side view of pressurized liquid reservoir vessel;

FIG. 4: depicts an exploded view of all sides of pressurized liquid reservoir vessel;

FIG. 5: depicts a side view of pressurized liquid reservoir vessel secured in U-shape rack;

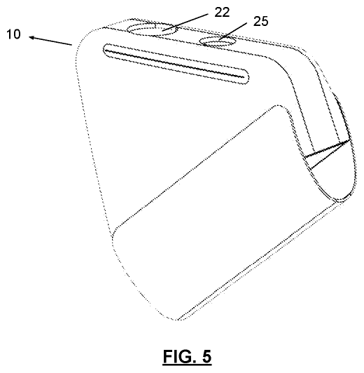

FIG. 6: illustrates a view reservoir holder with multiple brackets.

### DETAILED DESCRIPTION OF THE INVENTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skill in the art without departing from the scope of the invention.

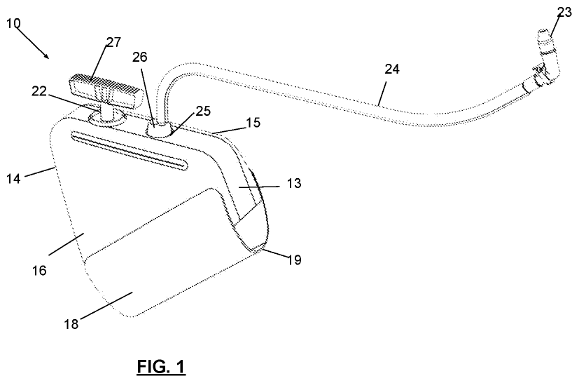

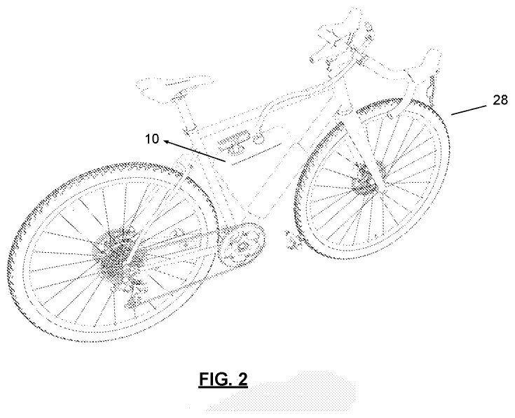

As shown in FIG. 1, the reservoir vessel 10 sits as close to the crankset as possible. The reservoir vessel 10 is a container for storing beverages like water, energy drinks, protein shakes, and the like. In a preferred embodiment of the invention, the non-standardized reservoir vessel 10 is a blow-molded prism located in the bottom vertex of a standard triangular bicycle 28 as can be seen in FIG. 2.

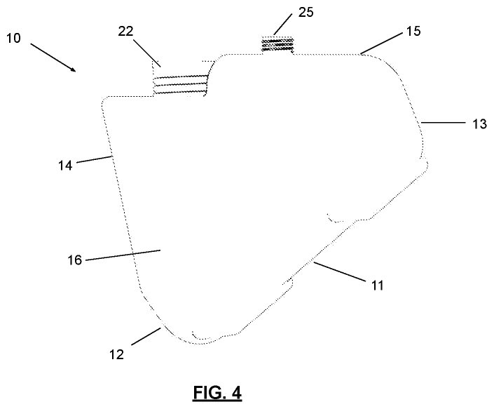

As shown in FIG. 1, the polygonal prism reservoir vessel 10 consists of five edges and a first and second surface separated by a thickness of the prism body. A first of the five edges is a bottom edge 11, as shown in FIG. 4, configured to be in close proximity to the down tube of a bicycle. The bottom edge 11 is substantially parallel to the down tube of the bicycle to which the reservoir vessel 10 is mounted. Extending from the bottom edge 11 are second edge 12 and third edge 13, as shown in FIG. 4, approximately at right angles to the bottom edge 11. The second edge 12 and the third edge 13 are substantially similar in length. The second edge 12 meets with a fourth edge 14 which extends at an angle away from the second edge 12. The fourth edge 14 is substantially parallel with the seat tube of the bicycle. As seen in FIG. 4, the third edge 13 meets with a fifth edge 15 which extends at an angle away from the third edge 13. The fifth edge 15 is substantially parallel with the top tube of the bicycle. The fifth edge 15 meets with the fourth edge 14 forming a polygonal shaped reservoir vessel.

The reservoir vessel 10 of the preferred embodiment is made from a softer collapsible plastic. In one embodiment, a metal can also be used to make the reservoir vessel as another option for riders to store their beverage.

The fifth edge 15 of the reservoir vessel 10 includes at least one opening as shown in FIGS. 1 and 4. The opening 22 is for receiving a pump 27 as it enters the reservoir vessel 10 from the top and also serves as the fill hole. In order to fill the reservoir vessel 10, the pump 27 is removed from the opening 22 and it is reinserted after the reservoir vessel 10 is filled. The first end of the pump 27 is received within the vessel 10. The pump 27 is then actuated until the reservoir vessel 10 is pressurized thereby providing a pressurized flow of water to the riders. Further, the reservoir vessel 10 being pressurized by the pump 27 maximizes the designated water storage space. In one embodiment, where there is only one opening, the second end of the pump 27 is configured with an attachment or adaptor to which hose is attached.

In another embodiment, a second opening 25 is positioned within fifth edge 15 of the reservoir vessel 10. The said second opening 25 may include an adaptor 26, as shown in FIG. 1, for connecting the hose 24. In one embodiment, the hose 24 is positioned along the top tube of the bicycle, as can be seen in FIG. 2. Whereas, in another embodiment the hose 24 may be positioned along the down tube of the bicycle. The hose 24 is further brought near the handlebars in order to provide water or any other beverage stored in the reservoir vessel to the rider. The hose 24 includes a nozzle 23 at the distal end which brings the water from the vessel up to an accessible place near the handlebars and thus making it easier for the rider to drink the liquid. In one another embodiment, the hose 24 can be molded in one piece directly with the reservoir vessel 10.

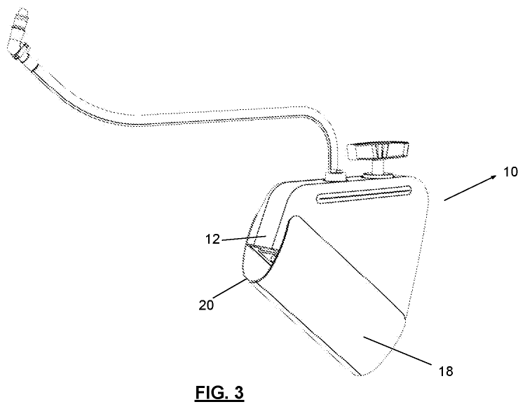

The first surface 16, as seen in FIG. 1, and second surface 17, as seen in FIG. 3, of the reservoir vessel 10 include a U-shaped wrap 18 around the bottom edge 11 of the reservoir vessel 10. The wrap 18 is spaced from the bottom edge 11 of the vessel 10 and covers half of the second edge 12 and third edge 13 of the reservoir vessel 10. The wrap 18 is U-shaped and is the same diameter as a standard water bottle or a reservoir vessel for bicycle thereby allowing the vessel 10 to be received smoothly in a clamp or bracket 21a of reservoir holder 21 in communication with a down tube of a bicycle or other vehicle.

The wrap 18 includes at least one top substantially u-shaped channel 19 at one end of the U-shaped wrap 18 located near the third edge 13 of the vessel 10. A second substantially bottom u-shaped channel 20, as shown in FIG. 3, can be positioned adjacent to the bottom edge 11 of the vessel and near the second edge 12 of the vessel. In this case, the top substantially u-shaped channel 19 and the bottom substantially u-shaped channel 20 are separated by a curved surface formed around the first and the second surfaces of the vessel 10. The substantially u-shaped channels 19, 20 respectively are parallel to the bottom edge 11 of the vessel 10. The U-shaped wrap 18 with its U-shaped channels 19, 20 at the ends is configured to allow for sliding of the reservoir vessel 11 within the bracket of reservoir vessel holder 21.

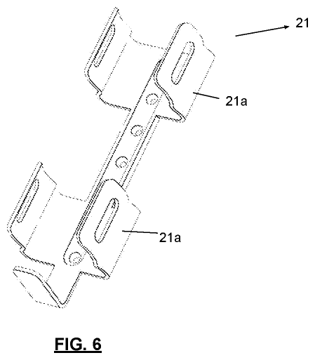

A reservoir vessel holder 21, as shown in FIG. 6, with a dovetail angle design can engage the bottom substantially U-shaped channel 20, the top substantially U-shaped channel 19 and the curved surface extending between the two U-shaped channels. The reservoir vessel holder 21 can be attached easily on the down tube of any bicycle and secures the reservoir vessel 10 in place within the frame of the bicycle. As seen in FIG. 6, the reservoir vessel holder 21 can include a single bracket, or multiple brackets 21a separated at a distance from one another along the down tube of the bicycle.

However, one of ordinary skill in the art will appreciate that, in certain embodiments, the liquid reservoir vessel can be a standardized water bottle. The standard water bottle slides smoothly in a dovetail mount and secured in the U-shaped wrap. The water bottle, received within a U-shaped wrap, is further retained using the dovetail angle design of the reservoir holder thus providing a very secure vessel mount for bicycle.

The reservoir vessel may further include an insulated cover. The insulated cover includes a shape substantially similar to that of the polygonal prism body of the reservoir vessel. It overlaps the U-shaped wrap which in turn surrounds the reservoir vessel or a standard water bottle thereby holding the U-shaped wrap in its place. The insulated cover would allow for maintaining a desired beverage temperature during the course of an excursion. It can keep the liquid hot or cold as desired by the rider. The insulated cover may include a Velcro strap, snap, button, zipper or any other fastening means which would allow the cover to be easily secured around the vessel and also easily removed from the reservoir vessel for cleaning.

The insulated cover and U-shaped wrap used in the present invention is made of TPU Silicone, various polymers, rubbers, expanded rubber, foam type of materials and the like. It can be made from a single material or a composite material. The materials can be molded, formed, bonded, or sewn construction.

To install the hydration system of the present invention, the users would first attach the brackets of the reservoir holder to the frame of the bicycle via m5 hex screws using standard bottle cage mount technology. The reservoir vessel is then received into the reservoir holder with the help of the U-shaped wrap placed around the bike tube. The reservoir vessel is further retained and secured using the snap tab lock along the length of both the reservoir vessel and the reservoir holder within a dovetail bracket mounted on the frame of the bicycle.

While many of the fundamental characteristics and features of the hydration system have been described herein, with reference to particular embodiments thereof, a latitude of modification, various changes and substitutions are intended in the foregoing disclosure, and it should be apparent that in some instances some features of the invention will be employed without a corresponding use of other features without departing from the scope of the invention as set forth. It should be understood that such substitutions, modifications, and variations may be made by those skilled in the art without departing from the spirit and scope of the invention. Consequently, all such modifications and variations are included within the scope of the invention as defined herein.

What is claimed is:

1. A hydration system affixed in the bottom vertex of a bicycle comprising:
a detachable polygonal prism reservoir vessel consisting of five edges and a first and a second surface separated by a thickness of the prism body;
wherein the first edge is a bottom edge configured to be in close proximity to the down tube of a bicycle and substantially parallel to the down tube of the bicycle;
wherein the second edge and third edge are approximately at right angles to the bottom edge;
wherein the second edge meets with a fourth edge which extends at an angle away from the second edge and the said fourth edge is substantially parallel with the seat tube of the bicycle;
wherein the third edge meets with a fifth edge which extends at an angle away from the third edge and the said fifth edge is substantially parallel with the top tube of the bicycle;
wherein the said fifth edge meets with the said fourth edge;
wherein the said reservoir vessel comprises a first opening and a second opening on the fifth edge of the vessel;
wherein the said first opening includes a pump when actuated provides a pressurized flow of water to the rider and the said second opening includes an adaptor for connecting a hose;
wherein the said hose is positioned along a tube of the bicycle and extended till the handlebar of the bicycle to provide water with a nozzle at its distal end;
a reservoir vessel holder with a dovetail angle design; wherein the said reservoir holder is mounted on the down tube of a bicycle and secures the reservoir vessel in place within the frame of the bicycle;
a U-shaped wrap around the bottom edge of the reservoir vessel to receive the reservoir vessel; wherein the said U-shaped wrap includes a top substantially u-shaped channel at one end near the third edge of the reservoir vessel and a bottom substantially u-shaped channel at the other end near the second edge of the reservoir vessel thereby forming a curved surface around the first surface and the second surface of the vessel and extending between the bottom and the top U-shaped channel;
wherein the reservoir holder engage the bottom substantially u-shaped channel, the top substantially u-shaped channel and the curved surface extending between the bottom U-shaped channel and the top U-shaped channel; and
an insulated cover with a shape substantially similar to that of the polygonal prism body of the reservoir vessel surrounding the U-shaped wrap, the reservoir holder and the reservoir vessel.

2. The hydration system affixed in the bottom vertex of a bicycle of claim 1, wherein the second edge and the third edge of the reservoir vessel are substantially similar in length.

3. The hydration system affixed in the bottom vertex of a bicycle of claim 1, wherein the pump when pressurizes the reservoir vessel effectively increases the water carrying capacity of the reservoir vessel.

4. The hydration system affixed in the bottom vertex of a bicycle of claim 1, wherein the hose is positioned along the top or bottom tube of the bicycle.

5. The hydration system affixed in the bottom vertex of a bicycle of claim 4, wherein the hose is preferably positioned along the top tube of the bicycle.

6. The hydration system affixed in the bottom vertex of a bicycle of claim 1, wherein the U-shaped wrap has the same diameter as a standard water bottle or a reservoir vessel.

7. The hydration system affixed in the bottom vertex of a bicycle of claim 1, wherein the reservoir vessel holder may include a single bracket or multiple brackets separated at a distance from one another to hold the reservoir vessel.

8. The hydration system affixed in the bottom vertex of a bicycle of claim 1, wherein the reservoir vessel is made of a soft collapsible plastic
